(19) United States
(12) Patent Application Publication
(10) Pub. No.: US 2015/0077566 A1
(43) Pub. Date: Mar. 19, 2015

(54) Method of Installing PIR Sensor with Camera

(71) Applicant: Honeywell International Inc., Morristown, NJ (US)

(72) Inventors: Zhimin Xiao, Shanghai (CN); Zhongwei Ding, Shanghai (CN)

(73) Assignee: Honeywell International Inc., Morristown, NJ (US)

(21) Appl. No.: 14/029,127

(22) Filed: Sep. 17, 2013

(51) Int. Cl. H04N 17/00; H04N 5/33; H04N 7/18

(52) U.S. Cl. CPC H04N 17/002; H04N 7/188; H04N 5/33
USPC 348/152

(57) ABSTRACT

A method and apparatus that includes the steps of receiving a PIR signal and video signal from a passive infrared (PIR) sensor having a PIR detector and camera, displaying a video image from the camera on a display, overlaying a range of the PIR detector and a magnitude of the PIR signal on the displayed video image, displaying a video image of a person walk testing the PIR sensor on the display in conjunction with the overlaid range and a magnitude of the PIR signal provided by the PIR detector and receiving an adjustment from the user of a detection threshold value of the PIR sensor based on the displayed image.

### FIELD

The field of the invention relates to PIR detectors and more particularly to methods of adjusting PIR detectors.

### BACKGROUND

Passive Infrared (PIR) detectors are generally known. Such devices are typically used in security systems for the detection of intruders.

PIR detectors typically include one or more radiation detectors intended to detect infrared energy from human intruders. Since PIR detectors are activated by infrared energy, they also have the ability to detect fire.

Since PIR detectors are activated by infrared energy, they are subject to false alarms. For example, when used in a residential context, they must be located at some minimum distance from the floor. This is often necessary to avoid the possibility of activation by small animals such as pets.

Even where mounted at an appropriate distance from the floor, they must be carefully adjusted for the dimensions of the space to be protected. For example, the farther from the floor that the PIR detector is mounted, the less infrared energy is received by the radiation detector. Accordingly, a sensitivity of the detector must be adjusted to avoid activation by small animals, yet low enough to detect humans. As such, the sensitivity of the PIR detector must be carefully adjusted to accommodate the space in which it is used. Accordingly, a need exists for easier and more reliable methods of adjusting PIR detectors.

### BRIEF DESCRIPTION OF THE DRAWINGS

FIG. 1 is a block diagram of a security system shown generally in accordance with an illustrated embodiment;

FIG. 2 is a PIR sensor that may be used with the system of FIG. 1;

FIG. 3 is an image that may be provided by the PIR sensor or system of FIG. 1; and

FIG. 4 is an image shown by the system of FIG. 1 during a walk test.

### DETAILED DESCRIPTION OF AN ILLUSTRATED EMBODIMENT

While embodiments can take many different forms, specific embodiments thereof are shown in the drawings and will be described herein in detail with the understanding that the present disclosure is to be considered as an exemplification of the principles hereof, as well as the best mode of practicing same. No limitation to the specific embodiment illustrated is intended.

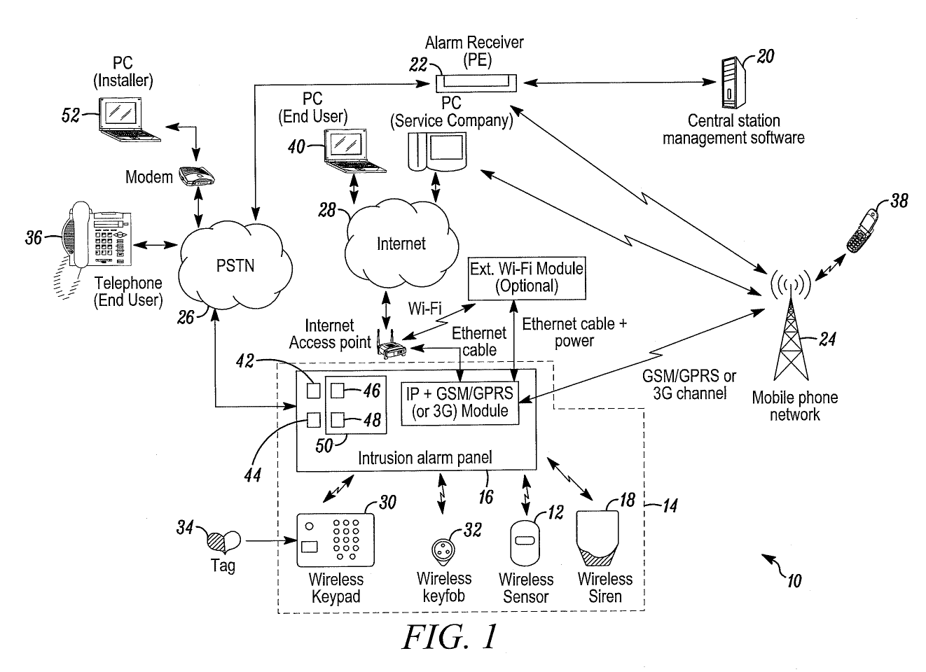

FIG. 1 is a block diagram of a security system 10 shown generally in accordance with an illustrated embodiment. Included within the security system may be one or more wireless sensors 12 that detect threats within a secured area 14. Threats in this case may be any event that threatens the health and safety of persons within the secured area (e.g., intruders, fire, etc.).

The sensors may monitored by a control panel 16. Upon detection of activation of a sensor, the control panel may send an alarm message to a central monitoring station 20 either through the PSTN 26 and alarm receiver 22 or through a cellular phone network 24 and alarm receiver 22.

In this regard, the security system (control panel) may be armed or disarmed through a wireless keypad 30, a wireless keyfob 32 or through a tag 34. The security system may also be remotely armed and disarmed through the PSTN 26 from a conventional telephone 36, through the cellular network 24 from a cellphone 38 or through the Internet 28 from a personal computer (PC) 40 of an end user.

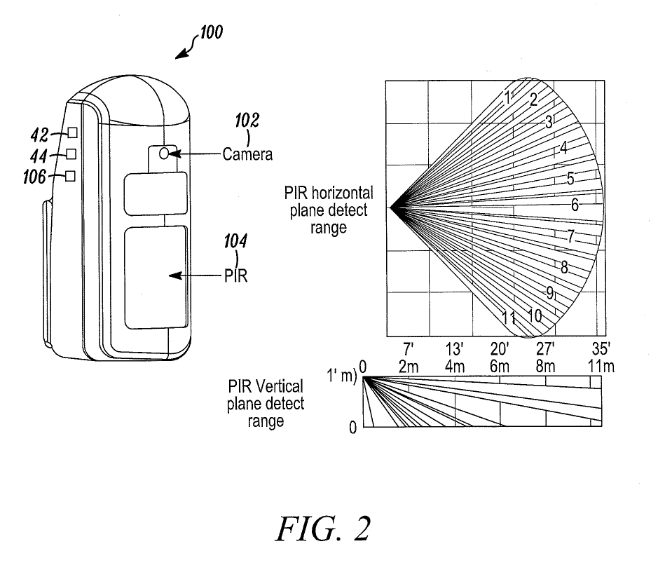

FIG. 2 is an example of a sensor 12 that may be used with the security system. FIG. 2, in this example, is a passive infrared (PIR) sensor 100. The PIR sensor includes a PIR detector 104 and a camera 102. The PIR sensor may also include a wireless transceiver 106 that communicates with the control panel through a corresponding transceiver located in the control panel.

Also shown the upper right and lower right of FIG. 2 are a set of detection characteristics of the PIR detector. As shown in the upper right, the PIR detector has a detection capability that extends outwards from a front of the IR sensor on each side approximately 45 degrees from a vertical centerline of the PIR detector. Stated in another way, the PIR detector has the ability to detect IR energy in a space that extends outwards from the front of the PIR sensor in a ninety degree angle. The lower right shows the vertical detection capabilities and that the PIR detector has the ability to detect IR energy from about 6 to more than 35 feet outwards from the PIR detector.

Included within the PIR sensor 100 and control panel 16 is one or more processor apparatus (processors) 42, 44 each operating under control of one computer programs 46, 48 loaded from a non-transient computer readable medium 50. As used herein, reference to a step of a program is also reference to the processor that executed that step.

The processors within the PIR sensor 100 allow the sensor to be set up for operation and used in a manner that is simple and straightforward. Under one embodiment, the PIR horizontal detection range shown in the upper right of FIG. 2 and the PIR vertical plane detection range of FIG. 2 are saved in a file in memory of the PIR sensor and used to overlay ranging information onto an image captured by the camera 102. For example, the camera is directed downward with regard to the housing of the sensor that allows the range of the detector to be calculated and superimposed onto the image from the camera.

For example, a ranging processor within the PIR sensor calculates a range based upon the downward angle of the camera and calculates a set of coordinates for displaying that information on a camera image.

Similarly, a PIR signal display processor retrieves a signal strength from the PIR detector and a high and low threshold values of the PIR sensor from memory. The signal strength and threshold can then be incorporated into a PIR signal strength display that may also be superimposed over the image from the camera.

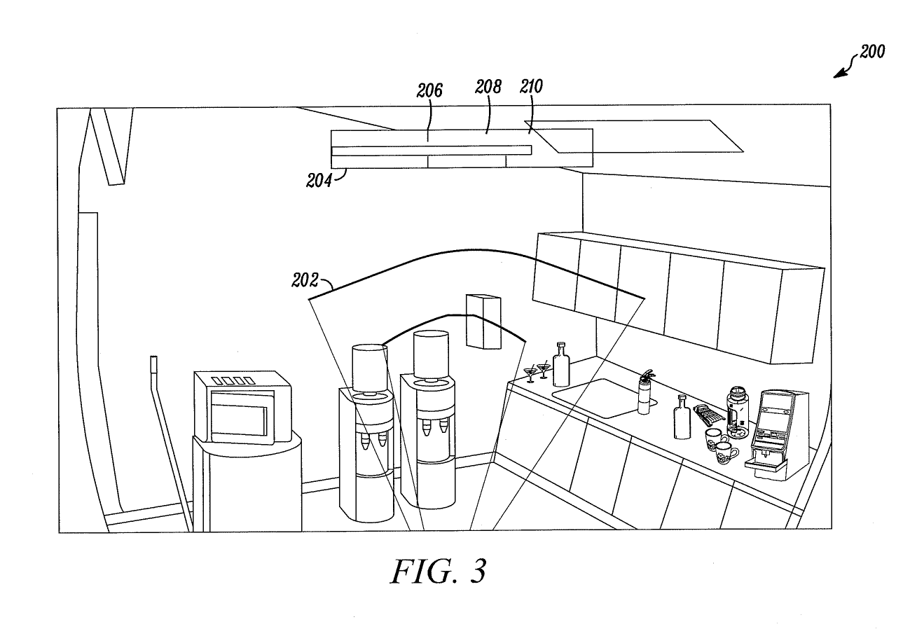

FIG. 3 depicts an image from the camera with overlaid information. In this regard, a locus of points 202 show the range of the PIR detector superimposed or otherwise overlaid onto the image. Similarly, the PIR signal strength display 204 shows a high threshold value 206, a low threshold value 208 and the instantaneous signal strength 210 from the PIR detector.

In order to set up the PIR sensor, an installer may connect a user interface such as a personal computer (PC) 52 to the control panel 16 through the PSTN 26 as shown in FIG. 1 or the installer may connect the PC 52 directly to the control panel 16. The installer may then access a setup routine (processor) within the control panel or PIR sensor. One of the options available and that may be activated by the installer is a walk test routine. The walk test routine may require entry of a time period (e.g., 5 minutes, 10 minutes, etc.).

Upon activating the walk test routine, a video processor continuously captures images from the camera and saves them in memory, either as captured or with the overlaid information of PIR detector range and signal strength. If the video is saved as captured, then the signals strength information is saved in a separate file along with timing information.

During the walk test, the installer may walk through the area in front of the PIR sensor. The installer may stop in any one or more locations where he/she wants to make sure that the PIR sensor is able to detect an intruder. At each location, the installer may perform some act such as holding up one or more fingers to signal the importance of the location during later review.

Upon completing the walk test routine, the installer may activate a test playback routine (and processor) to playback the images and superimposed information. The playback may be executed at the same number of frames per second as it was captured or the installer may step through the frames at some incremental number of frames per step.

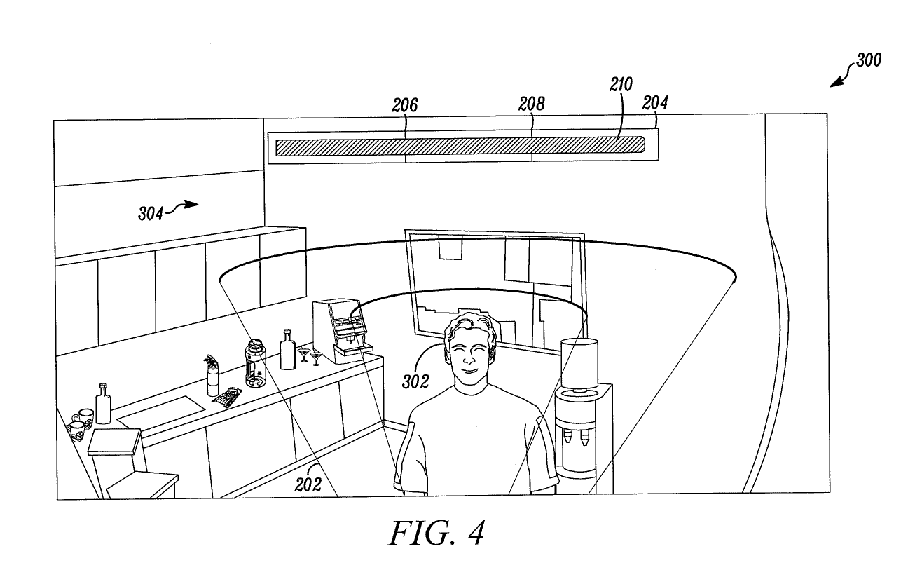

FIG. 4 is an example of a playback frame 300 that may be captured during a walk test showing the installer 302 displayed on a user interface. Overlaid over the frame are the range limits 202 of the detector. This is important because if the installer is standing in a location where is important for an intruder to be detected, the installer can confirm that the range limits 202 are directly over and surround the installer during that portion of the walk test. If not, then the installer can realign the PIR sensor with respect to the protected space.

The image 300 of FIG. 4 is also important because the installer can also directly observe the signal strength 210 from the PIR detector during each frame of the walk test. If the installer should decide that the threshold values are too high or low, the installer may simply place a cursor 304 over the high threshold 206 or low threshold 208 and drag them along the display 204 until they are properly positioned. Alternatively, the user interface may include one or more buttons or interactive windows that receive adjustments of one or both of the detection threshold values of the PIR sensor based upon the displayed image.

For example, if the installer in FIG. 4 were to consider the location of the installer in FIG. 4 to be the most important position in the room, then the installer may wish to increase one or both of the high and low threshold values. The installer may want to do this to reduce false alarms.

Once the installer has completed set up of the security system including one or more PIR sensors, the person owning or otherwise controlling the secured area may activate the alarm system. Once activated, the PIR detector may continuously monitor for intruders. In this regard, a signal processor may compare a signal level from the PIR detector with the one or more threshold values. During this time period, the camera 102 may be inactive or may store a limited number of images into local memory on a rolling basis.

If an intruder should pass in front of the PIR sensor, then the signal processor would detect the intruder due to an increase in the magnitude of the signal from the PIR detector above the threshold value. When this happens, a notification processor within the PIR sensor may compose and send an event message to the control panel. The event message includes at least an identifier of the PIR sensor, a time of the event and at least one image from the camera captured at the same time that the intruder was detected. The control panel, in turn, may save the event message and send an alarm message to the central monitoring station and, possibly, also to the owner or user of the secured area. The saving of the event message including the image from the camera of the PIR sensor offers confirmation at a later time that the event was not a false alarm and evidence of the identity of the intruder.

In general, the system may incorporate the steps of receiving a PIR signal and video signal from a passive infrared (PIR) sensor having a PIR detector and camera, displaying a video image from the camera on a display, overlaying a range of the PIR detector and a magnitude of the PIR signal on the displayed video image, displaying a video image of a person walk testing the FIR sensor on the display in conjunction with the overlaid range and a magnitude of the PIR signal provided by the PIR detector and receiving an adjustment from the user of a detection threshold value of the PIR sensor based on the displayed image.

Alternatively, the system includes a passive infrared (PIR) sensor including a PIR detector and a camera, a processor that receives a PIR signal from the PIR detector and video frame from the camera and that overlays a range of the PIR detector and a magnitude of the PIR signal on the video frame, a display that displays a video image of a person walk testing the PIR detector on the display in conjunction with the overlaid range and a magnitude of the PIR signal provided by the PIR detector and an input that receives an adjustment from the user of a detection threshold value of the PIR detector based on the displayed image.

As a still further alternative, the system includes a security system, a passive infrared (PIR) sensor of the security system including a PIR detector and a camera, a processor that receives a PIR signal from the PIR detector and video frame from the camera and that overlays a range of the PIR detector and a magnitude of the PIR signal on the video frame, a display that displays a video image of a person walk testing the PIR detector on the display in conjunction with the overlaid range and a magnitude of the PIR signal provided by the PIR detector and an input that receives an adjustment from the user of a detection threshold value of the PIR detector based on the displayed image.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims.

1. A method comprising:
receiving a PIR signal and video signal from a passive infrared (PIR) sensor having a PIR detector and camera;
displaying a video image from the camera on a display;
overlaying a range of the PIR detector and a magnitude of the PIR signal on the displayed video image;
displaying a video image of a person walk testing the PIR sensor on the display in conjunction with the overlaid range and a magnitude of the PIR signal provided by the PIR detector; and
receiving an adjustment from the user of a detection threshold value of the PIR sensor based on the displayed image.

2. The method as in claim 1 further comprising a processor comparing the magnitude with the adjusted threshold value and upon detecting that the magnitude exceeds the adjusted threshold value providing a PIR sensor output indicating detection of an intruder.

3. The method as in claim 2 further comprising a wireless transceiver of the PIR sensor forming a connection with a security system.

4. The method as in claim 3 further comprising the PIR sensor transmitting an intruder detected message to the security system.

5. The method as in claim 2 further comprising a processor of the PIR sensor capturing an image from the camera upon detecting an intruder and saving the captured image in memory.

6. The method as in claim 5 further comprising a processor transmitting the captured image to the security system.

7. The method as in claim 1 wherein the overlaid range further comprises a minimum detection range and a maximum detection range of the PIR sensor.

8. The method as in claim 7 wherein the overlaid range further comprises a detection angle including of two lines extending outward from the camera on the video image indicating a detection area within the video image of the PIR sensor.

9. An apparatus comprising:
a passive infrared (PIR) sensor including a PIR detector and a camera;
a processor that receives a PIR signal from the PIR detector and video frame from the camera and that overlays a range of the PIR detector and a magnitude of the PIR signal on the video frame;
a display that displays a video image of a person walk testing the PIR detector on the display in conjunction with the overlaid range and a magnitude of the PIR signal provided by the PIR detector; and
an input that receives an adjustment from the user of a detection threshold value of the PIR detector based on the displayed image.

10. The apparatus as in claim 9 further comprising a processor that compares the magnitude with the adjusted threshold value and upon detecting that the magnitude exceeds the adjusted threshold value provides a PIR sensor output indicating detection of an intruder.

11. The apparatus as in claim 10 further comprising a wireless transceiver of the PIR sensor that forms a connection with a security system.

12. The apparatus as in claim 11 further comprising a processor of the PIR sensor that transmits an intruder detected message to the security system.

13. The apparatus as in claim 11 further comprising a processor of the PIR sensor capturing an image from the camera upon detecting an intruder and saving the captured image in memory.

14. The apparatus as in claim 13 further comprising a processor transmitting the captured image to the security system.

15. The apparatus as in claim 9 wherein the overlaid range further comprises a minimum detection range and a maximum detection range of the PIR detector.

16. The apparatus as in claim 9 wherein the overlaid range further comprises a detection angle including of two lines extending outward from the camera on the video image indicating a detection area within the video image of the PIR detector.

17. An apparatus comprising:
a security system;
a passive infrared (PIR) sensor of the security system including a PIR detector and a camera;
a processor that receives a PIR signal from the PIR detector and video frame from the camera and that overlays a range of the PIR detector and a magnitude of the PIR signal on the video frame;
a display that displays a video image of a person walk testing the PIR detector on the display in conjunction with the overlaid range and a magnitude of the PIR signal provided by the PIR detector; and
an input that receives an adjustment from the user of a detection threshold value of the PIR detector based on the displayed image.

18. The apparatus as in claim 17 further comprising a processor that monitors the PIR for the detection of intruders.

19. The apparatus as in claim 18 further comprising a processor that sends an alarm message to a central monitoring station.

20. The apparatus as in claim 19 further comprising a processor that includes a processor that forwards an image from the camera of the PIR with the alarm message.
